(19) United States
(12) Patent Application Publication
(10) Pub. No.: US 2005/0031381 A1
(43) Pub. Date: Feb. 10, 2005

(54) Developing apparatus

(75) Inventor: Kota Arimoto, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/909,299

(22) Filed: Aug. 3, 2004

(30) Foreign Application Priority Data
Aug. 6, 2003 (JP) 2003-206380

(51) Int. Cl. G03G 15/08

(52) U.S. Cl. 399/258

(57) ABSTRACT

A developing apparatus having a developer carrying member for carrying and conveying developer including toner and carrier to a portion opposed to an image bearing member, a first chamber for supplying the developer to the developer carrying member, a first conveying portion disposed in the first chamber for conveying the developer, a second chamber for supplying the developer to the first chamber, a second conveying portion disposed in the second chamber for conveying the developer, and a receiving port for receiving a supplied toner, wherein the developer is circulated between the first chamber and the second chamber by the first and the second conveying portion, the second conveying portion is inclined so that the downstream side in a developer conveying direction may be upper in the direction of gravity, and the supplied toner from the receiving port is supplied from just above the second conveying portion in the direction of gravity to the second conveying portion.

### BACKGROUND OF THE INVENTION

1. Field of the Invention

The invention relates to a developing apparatus for use in an image forming apparatus using an electrophotographic process or an electrostatic recording process such as a copying machine, a printer or a facsimile apparatus.

2. Description of Related Art

Due to an increase of needs for colored images in recent years, a lower cost and downsizing of an apparatus have come to be required in an image forming apparatus for effecting colored image forming as well as in a black-and-white image forming apparatus.

In conventional image forming apparatus using the electrophotographic process, and above all, image forming apparatuses for effecting colored image forming, a two-component developing process using a mixture of a nonmagnetic toner(toner) and a magnetic carrier(carrier) as a developer is widely utilized, and the two-component developing process, as compared with presently proposed other developing processes, has such merits as the stability of the quality of image and the durability of the apparatus.

When in a developing apparatus using the two-component developing process (a two-component developing apparatus), developing is effected with a toner supplied to an image bearing member, the toner density in the developer (the rate of he toner and the carrier, or the rate of the toner to the entire developer) is gradually lowered. To prevent this lowering of the toner density, it is necessary to supply a fresh toner.

FIG. 10 of the accompanying drawings shows a conventional popular two-component developing apparatus. As prior art document regarding such a two-component developing apparatus, mentioned may be made, for example, of Japanese Patent Application Laid-Open No. Sho 55-32060.

The developing apparatus 101 has a developing container 102 for containing a developer therein. A portion of the developing container 102 which is opposed to an image bearing member which is a member to be developed opens, and a developing sleeve 111 as a developer carrying member for supplying the developer to the image bearing member is rotatably disposed in such a manner as to be partly exposed from this opening portion. The developing container 102 has a developing chamber (first developer containing chamber) 121 disposed along the axial direction of the developing sleeve 111 for supplying the developer to the developing sleeve 111, and an agitating chamber (second developer containing chamber) 122 for conveying the developer in a direction opposite to the developing chamber 121 while mixing and agitating a supplied toner and the developer in the developing container 102. The developing chamber 121 and the agitating chamber 122 are compacted by a partition wall 125, and in the lengthwisely opposite end portions thereof, there are formed a first communicating portion 123 and a second communicating portion 124 which permit the passage of the developer therethrough. Conveying members (developer conveying and agitating members) 113 and 114 for effecting the conveyance and agitation of the developer are disposed in the developing chamber 121 and the agitating chamber 122, respectively, whereby the developer is circulated (in a direction indicated by the arrow D in FIG. 10) between the developing chamber 121 and the agitating chamber 122 through the first communicating portion 123 and the second communicating portion 124.

A toner supplied to the developing container 102 usually by the fall from gravity at a toner supplying position T is agitated with the developer in the developing container 102 in the agitating chamber 122, whereby it contacts with a carrier and is frictionally charged. If, however the agitation in the agitating chamber 122 is insufficient, the supplied toner is conveyed from the first communicating portion 123 to the developing chamber 121 and used for the developing operation while it is not sufficiently charged and therefore, toner fog may occur to the blank portion of an image, thus resulting in the deterioration of the quality of the image.

To prevent such toner fog, the supplied toner can be sufficiently charged while it is conveyed to the first communicating portion 123. As means therefore, in the conventional developing apparatus 101, the distance from the toner supplying position T in the agitating chamber 122 to the first communicating portion 123 (hereinafter referred to the “agitation distance”) L is suitably set.

In the conventional developing apparatus 101, however, it has often been the case that the agitation distance L has been suitably set in order to sufficiently frictionally charge the toner supplied into the developing container 102, with a result that the agitation distance L has become greater than an image forming width G.

For example, in the developing apparatus 101 of FIG. 10, the toner supplying position T is provided upstream of an image forming region (image forming width G) to thereby secure the agitation distance L necessary to sufficiently charge the supplied toner.

Generally, a minimum length in the lengthwise direction required of the developing apparatus 101 is nothing but the image forming width G. In the developing apparatus 101 shown in FIG. 10, the agitation distance L is greater than the image forming width G in order to sufficiently charge the supplied toner while it is conveyed to the first communicating portion 123. This not only hinders the downsizing of the developing apparatus 101, but also hinders the downsizing of the entire image forming apparatus.

### SUMMARY OF THE INVENTION

It is the object of the present invention to provide a developing apparatus improved in a charge giving property to a toner during the conveyance of a developer.

A preferred developing apparatus for achieving the above object comprises:

a developer carrying member for carrying thereon a developer including a toner and a carrier, and conveying the developer to a portion opposed to an image bearing member;

a first developer containing chamber for supplying the developer to the developer carrying member;

first conveying means disposed in the first developer containing chamber for conveying the developer;

a second developer containing chamber for supplying the developer to the first developer containing chamber;

second conveying means disposed in the second developer containing chamber for conveying the developer; and

a receiving port for receiving the supplied toner,

wherein the developer is circulated between the first developer containing chamber and the second developer containing chamber by the first conveying means and the second conveying means,

the second conveying means is disposed while being inclined so that the downstream side thereof with respect to a developer conveying direction may be higher in the direction of gravity, and

the supplied toner from the receiving port is supplied from just above the second conveying means in the direction of gravity to the second conveying means.

### BRIEF DESCRIPTION OF THE DRAWINGS

FIG. 1 is a schematic cross-sectional view of an example of an image forming apparatus to which the present invention is applicable.

FIG. 2 is a schematic cross-sectional view of an embodiment of a developing apparatus according to the present invention.

FIG. 3 is a top plan view of the embodiment of the developing apparatus according to the present invention.

FIG. 4 is a typical view for illustrating a toner cartridge.

FIG. 5 is a schematic cross-sectional view of another embodiment of the developing apparatus according to the present invention.

FIG. 6 is a schematic cross-sectional view of still another embodiment of he developing apparatus according to the present invention.

FIG. 7 is a schematic cross-sectional view of an embodiment of a process cartridge according to the present invention.

FIG. 8 is a graph for illustrating a toner charge giving property in the developing apparatus according to the present invention.

FIGS. 9A and 9B are typical views for illustrating the movement of a developer in an agitating chamber in the developing apparatus according to the present invention.

FIG. 10 is a top plan view of an example of a conventional developing apparatus.

### DETAILED DESCRIPTION OF THE PREFERRED EMBODIMENTS

An image forming apparatus provided with a developing apparatus according to the present invention will hereinafter be described in detail with reference to the drawings.

First Embodiment

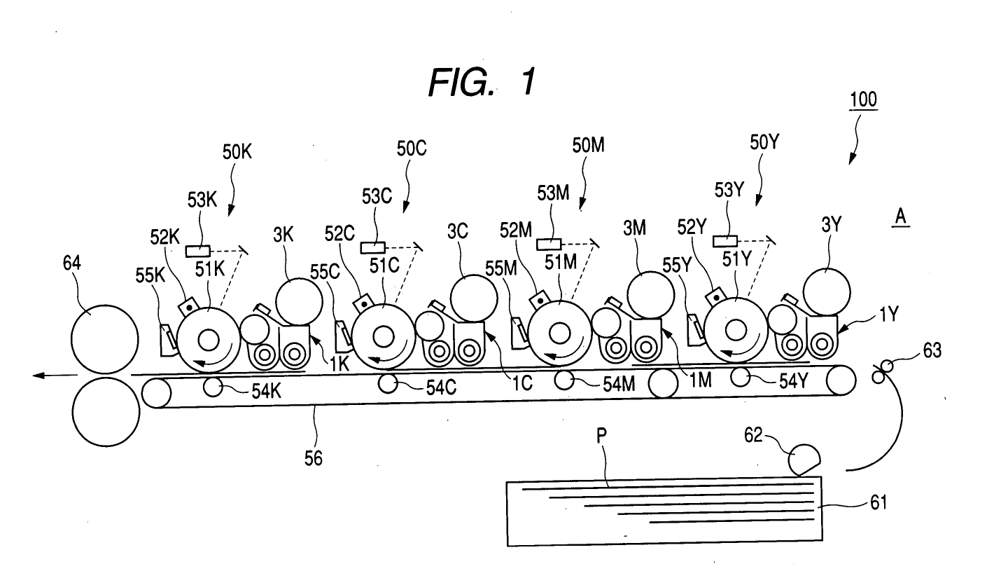

FIG. 1 shows a schematic cross section of an embodiment of an image forming apparatus 100 to which the present invention is applied. The image forming apparatus 100 of the present embodiment is a color electrophotographic image forming apparatus provided with four image forming portions 50Y, 50M, 50C and 50K for forming yellow (Y), magenta (M), cyan (C) and black (K) images, respectively, as a plurality of image forming means. The image forming apparatus 100 can form a color image on a recording material P such as, for example, recording paper, an OHP sheet or cloth in conformity with an image information signal from an external host device such as a personal computer connected to an apparatus main body A for communication therewith, or an original reading apparatus belonging to or connected to the apparatus main body A for communication therewith.

The operation of the whole of the image forming apparatus 100 will first be described. In the present embodiment, the image forming portions 50Y, 50M, 50C and 50K provided in the image forming apparatus 100 basically have the same construction, and differ in the colors of images to be formed. Accordingly, hereinafter, when distinction is not especially needed, the suffixes Y, M, C and K given the reference numerals in the drawings to indicate elements belonging to any one of the image forming portions will be omitted and description will be made in the gross.

The image forming portion 50 has as an image bearing member a drum-shaped electrophotographic photosensitive member (photosensitive drum) 51 rotatable in the direction indicated by the arrow in FIG. 1. During image forming, the surface of the photosensitive drum 51 being rotated is first charged by a primary charging device 52 as charging means. The charged surface of the photosensitive drum 51 is scanned and exposed in conformity with a color-resolved image information signal corresponding to each image forming portion 50, by a laser scanner 53 as image writing means (exposing means), thereby forming on the photosensitive drum 51 an electrostatic image conforming to an image information signal of a corresponding color. This electrostatic image is then developed with a toner by a developing apparatus 1 to thereby form a toner image on the photosensitive drum 51.

A conveying belt 56 as recording material conveying means is disposed so as to be endlessly movable in opposed relationship with the photosensitive drum 51 of each image forming portion 50. At a location opposed to the photosensitive drum 51 of each image forming portion 50 with the conveying belt 56 interposed therebetween, there is provided a transfer charging device 54 as transferring means. The toner image formed on the photosensitive drum 51 in the manner described above is transferred onto the recording material P on the conveying belt 56 by a transfer bias applied by the transfer charging device 54.

The recording material P is conveyed from a cassette 61 which is a recording material containing portion to registration rollers 63 by recording material supplying means such as a pickup roller 62, and is fed out from there to the conveying belt 56 in such a manner as to be in synchronism with an image forming operation in each image forming portion 50.

The image forming operation as described above is performed in each of the yellow, magenta, cyan and black image forming portions 50, whereby the toner images are successively transferred to the recording material P conveyed on the conveying belt 56, and a conveyed on the conveying belt 56, and a desired full-color image can be formed on the recording material P.

Thereafter, the recording material P is stripped off from the conveying belt 56 and is conveyed to a fixing apparatus 64. By being pressurized and heated by the fixing apparatus 64, the toner image transferred onto the recording material P becomes a permanent image. Also, any untransferred toner residual on the photosensitive drum 51 after the transfer is removed by a cleaning apparatus 55 having a blade-shaped cleaning member as cleaning means, and the photosensitive drum becomes ready for the next image forming.

The developing apparatus 1 will now be described.

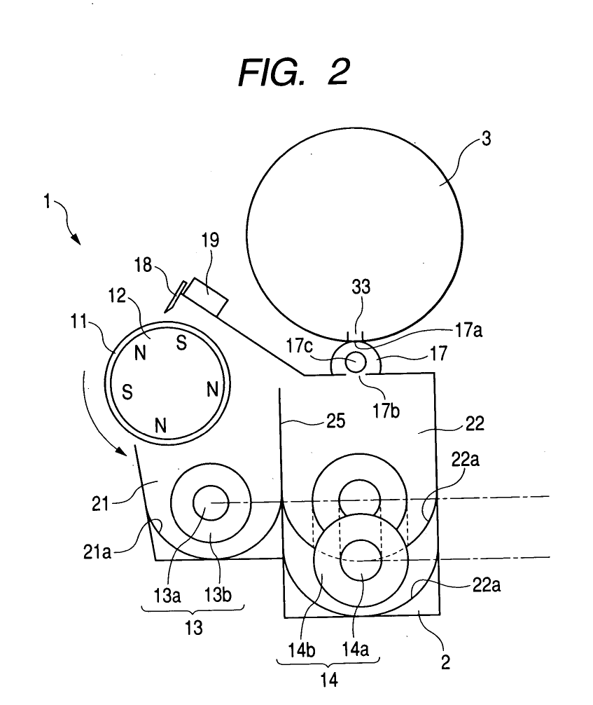

As shown in FIG. 2, the developing apparatus 1 has a developing container 2 for containing a developer therein. In the developing container 2, there is contained a two-component-developer provided with chiefly a nonmagnetic toner (toner) and a magnetic carrier (carrier) as the developer. The toner density in the developer in its initial state is 7% by weight in the present embodiment. This value, however, should be properly adjusted in conformity with the charge amount of the toner, the particle diameter of the carrier, the construction of the image forming apparatus, etc., and need not always be compulsory.

A portion of the developing container 2 which is opposed to the photosensitive drum 51 opens, and a developing sleeve 11 as a developer carrying member is rotatably disposed in this opening portion in such a manner as to be partly exposed. The developing sleeve 11 is formed of a nonmagnetic material and contains a stationary magnet 12 as magnetic field generating means therein. In the present embodiment, the magnet 12 has a plurality of magnetic poles along the outer periphery thereof. During a developing operation, the developing sleeve 11 is rotated in the direction indicated by the arrow in FIG. 2, and holds the two-component developer in the developing container 2 in a layer shape and conveys it to a developing area opposed to the photosensitive drum 51. The developer carried on the developing sleeve 11 forms a magnetic brush comprising a developer which stands like the ears of rice in the developing area, and this magnetic brush is brought into contact with or brought close to the surface of the photosensitive drum 51, and the toner in the two-component developer is supplied to the photosensitive drum 51 side in conformity with the electrostatic image formed on the surface of he photosensitive drum 51 to thereby develop the electrostatic image.

Usually, during at least the developing operation, a predetermined developing bias is applied to the developing sleeve 11, and by the action of an electric field formed between the photosensitive drum 51 and the developing sleeve 11, the toner is shifted to the photosensitive drum 51. Also, in order to regulate the amount of developer carried on the developing sleeve 11, developing amount regulating means 18 cooperating with the magnet 12 to regulate the thickness of the developer layer by the action of a magnetic field is provided upstream of the developing area with respect to the rotational direction of the developing sleeve 11.

The developer after having developed the electrostatic image on the photosensitive drum 51 is conveyed in accordance with the rotation of the developing sleeve 11, and is collected into the developing chamber (first developer containing chamber) 21 of the developing container 2 which will be described later.

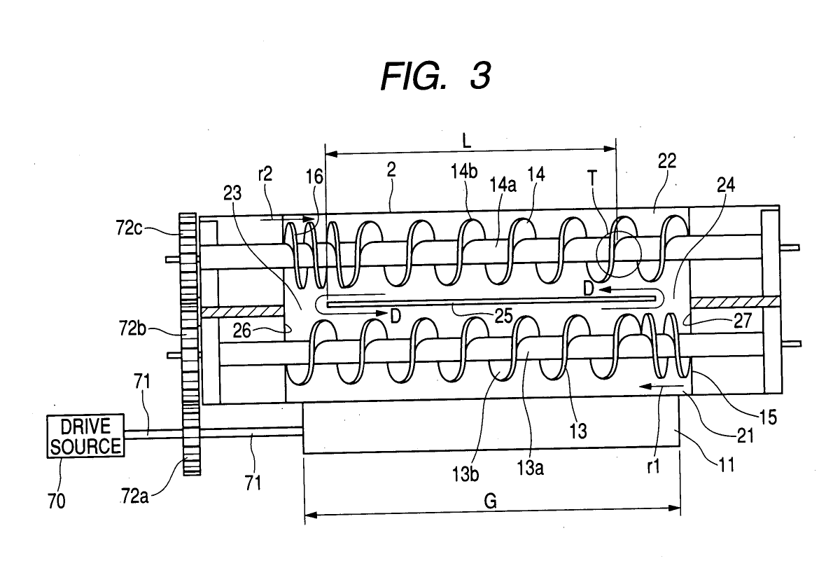

Referring also to FIG. 3, the developing container 2 is substantially bisected into a developing chamber (first developer containing chamber) 21 (a side near to the developing sleeve 11) and an agitating chamber (second developer containing chamber) 22 (a side far from the developing sleeve 11) by a partition wall 25. In the present embodiment, the developing chamber 21 and the agitating chamber 22 extend along the axial direction of the developing sleeve 11. The partition wall 25 does not reach the side walls 26 and 27 of the lengthwisely opposite end portions of the interior of the developing container 2, whereby there are formed a first communicating portion 23 and a second communicating portion 24 permitting the passage of the developer between the developing chamber 21 and the agitating chamber 22.

Circulating means for circulating the developer between the developing chamber 21 and the agitating chamber 22 is provided in the developing chamber 21 and the agitating chamber 22. This circulating means has a first screw 13 and a second screw 14 as conveying members for effecting the conveyance and agitation, respectively, of the developer along the axial direction of the developing chamber 21 and the agitating chamber 22. By the first screw 13 and the second screw 14, the developer is mixed and agitated while being circulated in the developing container 2. The direction of circulation of the developer in the developing apparatus 1 of the present embodiment is a direction from the inner side toward this side of he plane of the drawing sheet of FIG. 2 in the developing chamber 21, and a direction from this side toward the inner side of the plane of the drawing sheet of FIG. 2 in the agitating chamber 22 (the direction indicated by the arrow D in FIG. 3).

In the developing apparatus 1 of the present embodiment, a driving force from a drive source 70 which is a drive motor provided in the image forming apparatus main body A is transmitted to the developing sleeve 11 through a rotary shaft 71 as drive transmitting means. Also, this driving force is transmitted to the first screw 13 and the second screw 14 through gear systems 72a, 72b and 72c as drive transmitting means.

In the present embodiment, the first screw 13 and the second screw 14 have rotary shafts 13a and 14a, respectively, provided substantially in parallelism to the axial direction of the developing chamber 21, and the agitating chamber 22, and spiral conveying portions (wing portions or spiral members) 13b and 14b, respectively, provided around the rotary shafts. In the present around the rotary shafts. In the present embodiment, both of he first screw 13 and the second screw 14 are such that the diameters of the rotary shafts 13a and 14a thereof are 6 mm, and comprise the spiral conveying portions 13b and 14b having a diameter of 16 mm disposed at an interval of 15 mm on the peripheral surfaces of the shafts.

In the present embodiment, on the downstream end portions of the first screw 13 and the second screw 14 with respect to the developer conveying direction, there are provided return members 15 and 16 comprising screws provided coaxially with the first screw 13 and the second screw 14 and so that the developer conveying direction may be opposite directions thereto (the directions indicated by the arrows r1 and r2 in FIG. 3), i.e., a first return member 15 and a second return member 16 comprising spiral conveying portions (wing portions) disposed on the peripheral surfaces of the rotary shafts 13a and 14b. Thereby, in the downstream end portions of the first screw 13 and the second screw 14 with respect to the developer conveying direction, the developer is pushed back in the direction opposite to the developer conveying direction (the direction indicated by the arrow D in FIG. 3) to thereby smooth the delivery of the developer in the first communicating portion 23 and the second communicating portion 24.

The circulation route of the developer will be described later in greater detail, but in the present embodiment, design is made such that the bottom surface (bottom portion) of the agitating chamber 22 is upwardly inclined from the upstream side toward the downstream side with respect to the circulation direction of the developer at a predetermined angle with respect to the horizontal direction and a flow of the developer in the direction opposite to the circulation direction of the developer is formed in the agitating chamber 22 above the second screw 14.

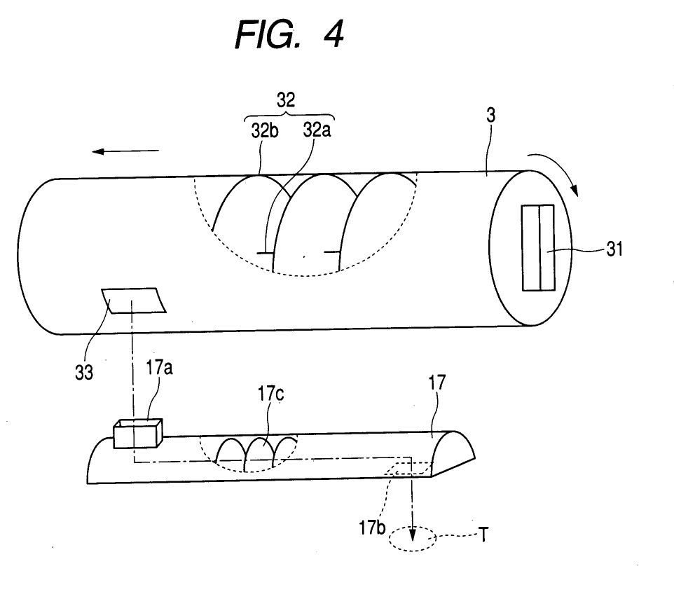

A toner cartridge 3 containing therein the toner to be supplied as a developer supplying container is substantially cylindrical, as shown in FIG. 4, and is easily mountable on and detachable from the image forming apparatus main body A and the developing apparatus 1. The toner cartridge 3 is inserted into the image forming apparatus main body A from this side thereof (this side of the planes of the drawing sheets of FIGS. 1 and 2) with the lengthwise end portion thereof opposite to the side provided with a handle 31 as the head, and the handle 31 on this side is twisted to the right side and rotated, whereby a shutter (not shown) provided so as to open and close a supplying port 33 is opened, and the supplying port 33 is opened. Therewith, the supplying port 33 and the receiving port 17a of a developer supplying mechanism 17 provided in the developing container 2 are connected together and the toner to be supplied becomes capable of passing therethrough.

When the toner cartridge 3 is to be detached from the image forming apparatus main body A, the handle 31 is twisted to the left side to thereby close the supplying port 33. The handle 31 is pulled toward this side, whereby the toner cartridge can be detached from the image forming apparatus main body A and the developing apparatus 1. Thus, it never happens that the powder material contained in the toner cartridge 3 leaks to the outside.

Also, in the toner cartridge 3, there is provided a conveying member 32 for conveying the supplied toner. The interior of the toner cartridge 3 is partly shown in FIG. 4, and in the present embodiment, the conveying member 32 has a rigid rotary shaft 32a disposed substantially in parallelism to the axial direction of the toner cartridge 3, and a conveying portion (wing portion) 32b (such as resin film) spirally disposed around the rotary shaft 32a. By the rotary shaft 32a being suitably rotatively driven, the toner in the toner cartridge 3 is conveyed, thus assisting the supply.

An amount of toner consumed by image forming is conveyed from the toner cartridge 3 into the developer supplying mechanism 17 through the supplying port 33 and the receiving port 17a of the developer supplying mechanism 17 disposed in the developing container 2. Then, in accordance with the rotation of a supplying screw 17c as developer supplying means provided in the developer supplying mechanism 17, the toner in the developer supplying mechanism 17 is supplied into the agitating chamber 22 of the developing container 2 through a supplying port 17b. The supplying port 17b is located just above the toner supplying position T in the agitating chamber 22 with respect to the direction of gravity, and the toner discharged from the supplying port 17b is directly thrown into the agitating area of the supplying screw 14a. By being thus directly thrown into the agitating area, it becomes easy for the toner to be introduced into the supplying screw 14a, and the agitating performance thereof heightens. The supplying screw 17c is driven so that for example, a necessary amount of toner may be suitably supplied to the developing container 2 in conformity with a toner supply amount obtained on the basis of the consumed amount information on the like of the toner calculated (integrated) from the density information of each pixel based on the detection signal of a reflection type optical sensor 19 as toner density detecting means provided in the developing apparatus 1, or the image information signal of each color.

Description will now be made of the developer used in the present embodiment. As described above, in the present embodiment, use is made of the two-component developer provided with chiefly the nonmagnetic toner (toner) and the magnetic carrier (carrier).

The toner is negatively chargeable polyester resin having coloring resin particles containing binding resin, a coloring agent and other additive as required, and coloring particles having an additive such as colloidal silica fine powder extraneously added thereto, and the volume average particle diameter thereof may preferably be 5 μm or greater and 9 μm or less. In the present embodiment, it was 7.2 μm.

As the carrier, use can suitably be made, for example, of a metal such as surface-oxidized or unoxidized iron, nickel, cobalt, manganese, chromium or rare earth, and an alloy thereof, or ferrite oxide, and the method of manufacturing these magnetic particles is not particularly limited. The weight average particle diameter of the carrier is 20-50 μm, preferably 30-40 μm, and the resistivity thereof is 10⁷ Ωcm or greater, preferably 10⁸ Ωcm or greater. In the present embodiment, use was made of a carrier having resistivity of 10⁸ Ωcm.

Regarding the toner used in the present embodiment, the volume average particle diameter thereof was measured by an apparatus and a method shown below. As a measuring apparatus, use was made of COULTER Counter TA-II type (produced by COULTER Inc.), an interface (produced by Nikkaki) for outputting a number average distribution and a volume average distribution, and CX-I personal computer (produced by Canon Inc.), and as an electrolytic water solution, use was made of 1% NaCl water solution prepared by the use of first class sodium chloride. The measuring method is as shown below. That is, as a dispersing agent, an interfacial active agent, preferably 0.1 ml of alkyl benzene sulfonate is added to 100-150 ml of the above-mentioned electrolytic water solution, and 0.5-50 mg of measuring sample is added. The electrolytic water solution in which the sample is suspended is subjected to a dispersing process by an ultrasonic dispersing device for about 13 minutes, and the particle size distribution of particles of 2-40 μm is measured by the above-mentioned COULTER Counter TA-II type by the use of a 100 μm aperture as an aperture to thereby obtain a volume average distribution. A volume average particle diameter is obtained from the thus obtained volume average distribution.

Also, the resistivity of the carrier used in the present embodiment was measured by a method of obtaining the resistivity of the carrier from an electric current flowing to a circuit with a applied voltage E (V/cm) between two electrodes applied under the pressure of a weight of 1 kg on one electrode by the use of a sandwich type cell having a measuring electrode are of 4 cm and an inter-electrode interval of 0.4 cm.

Description will further be made of the circulation route of the developer in the developing container 2 which is most characteristic in the present embodiment.

Referring to FIGS. 2 and 3, in the developing apparatus 1 of the present embodiment, the bottom surface (bottom portion) 22a of the agitating chamber 22 has an inclination of 5 degrees with respect to a horizontal direction. Thus, the agitating chamber 22 is in a twisted positional relation to the developing sleeve 11. An inclination of upward gradient is provided in the upstream to the downstream direction with respect to the developer conveying direction (the direction indicated by the arrow D in FIG. 3) in the agitating chamber 22, whereby particularly as will be described later, the charge giving property to the toner in the agitating chamber 22 can be remarkably improved. On the other hand, the bottom surface 21 of the developing chamber 21 is disposed substantially in a horizontal direction, i.e., here, substantially in parallelism to the developing sleeve 11, for the stable supply of the developer to the entire lengthwise area of the developing sleeve 11.

Herein, being horizontal with respect to the orientation of the developing chamber 21 and the agitating chamber 22 is in the ordinary used state of the developing apparatus 1 (developing container 2) and the image forming apparatus 100. Also, being horizontal does not mean only being strictly horizontal, but may deviate from the horizontal to such a degree that there is no problem in the ordinary use of the developing apparatus 1 (developing container 2) and the image forming apparatus 100. Typically, being horizontal with respect to the orientation of the developing chamber 21 and the agitating chamber 22 corresponds to the axial direction as the whole of the developing apparatus 1 (developing container 2).

Also, in the present embodiment, in the first communicating portion 23 for delivering the developer from the agitating chamber 22 to the developing chamber 21, the bottom surface 22a of the agitating chamber 22 and the bottom surface 21a of the developing chamber 21 are at the same position in a vertical direction, and in the second communicating portion 24 for delivering the developer from the developing chamber 21 to the agitating chamber 22, the bottom surface 22a of the agitating chamber 22 is at a lower position in the vertical direction than the bottom surface 21a of the developing chamber 21.

Accordingly, in the first communicating portion 23, smooth delivery of the developer from the agitating chamber 22 to the developing chamber 21 is possible because the two bottom surfaces 21a and 22a are at the same position in the vertical direction. Also in the second communicating portion 24, smooth delivery is possible because the delivery of the developer is effected by the falling movement of the developer from the developing chamber 21 to the agitating chamber 22.

In the developing apparatus 1 of the present embodiment, the image forming width G is 305 mm, and the lengths of the developing chamber 21 and the agitating chamber are likewise 305 mm.

The toner supplying position T in the developing apparatus 1 of the present embodiment is a position downstream by 10 mm of the second communicating portion 24 provided in the agitating chamber 22 at one lengthwise end portion of the developing chamber 21 and the agitating chamber 22.

As described above, in the developing apparatus 1 of the present embodiment, it becomes possible to shorten the length of the developing container 2 by following the present invention, and particularly, the distance (agitation distance) L from the toner supplying position T in the agitating chamber 22 to the first communicating portion 23 can be made shorter than the image forming width G. Description will hereinafter be made in greater detail.

Here, description will be made of the result of an experiment about the charge giving property to the toner supplied into the developing container 2 in the developing apparatus 1 of the present embodiment.

### EXPERIMENT EXAMPLE 1

In this experiment, 1 gm of toner was supplied at the toner supplying position T, and the charge amount of this supplied toner in the first communicating portion 23 was measured. In the present experiment, the measurement was carried out with the inclination of the agitating chamber 22 with respect to the horizontal direction (the upward gradient from the second communicating portion 24 side toward the first communicating portion 23 side) (hereinafter simply referred to as the “inclination”) θ as 0 degree (horizontal), 1 degree, 2 degrees, 5 degrees, 10 degrees and 12 degrees. Respective sample developing apparatuses were of the same construction with the exception that this inclination differs.

The result of the experiment is shown in Table 1 below. The toner chargeability in Table 1 is such that the charge amount of 3,000 toners was measured by E-Spart Analyzer produced by HOSOKAWAMICRON Corp., and a case where substantially all toners are of the negative polarity is good (O), and a case where the toners are not frictionally charged (charged amount 0) or are of the positive polarity is bad (X).

The toner causing the toner fog of the blank portion of an image is toner of a polarity (the positive polarity in the case of the toner in the present embodiment) opposite to the regular polarity, or a charge amount 0, as is well known. Accordingly, if substantially all of the supplied toner is of the negative polarity in the first communicating portion 23, toner fog will not occur.

Also, the developer convey ability in Table 1 is the state of developer conveyance in the agitating chamber 22 as it was subjectively evaluated by the inventor, and a case where developer conveyance is effected in the upstream to downstream direction is good (O), and a case where it is not effected is bad (X).

TABLE 1

| Inclination | 0° | 1° | 2° | 5° | 10° | 12° |
|---|---|---|---|---|---|---|
| Toner Chargeability | X | X | ◯ | ◯ | ◯ | — |
| Developer Conveyability | ◯ | ◯ | ◯ | ◯ | ◯ | X |

Also, FIG. 8 shows the result of the toner chargeability in the present experiment. If the inclination of the agitating chamber 22 is 1 degree or less, a toner charged to the positive polarity and a toner of a charge amount 0 are present in the first communicating portion 23, but if the inclination is 2 degrees or greater, substantially all of the toner is charged to the negative polarity.

The present invention does not intend to be restricted by any theory, but a mechanism by which the present invention acts preferably will hereinafter be considered.

To sufficiently frictionally charge the toner supplied to the developing apparatus 1, it is considered that the following three kinds of performance are required of the agitating chamber 22.

1) The introducibility with which the supplied toner is introduced into the developer

2) The dispersing property with which the supplied toner is loosened

3) The mixability with which the supplied toner is mixed with the carrier in the developer

These will hereinafter be described.

1) Generally, the toner supply to the developing apparatus is often effected by a method of causing the toner to freely fall onto the developer circulating in a developer circulation route, but in the case of this method, the supplied toner is liable to waft on the developer. To mix the supplied toner with the carrier in the developer, it is necessary to introduce the supplied toner wafting on the developer into the developer. Therefore, in a popular developing apparatus, the supplied toner is introduced into the developer by a so-called screw comprising a spiral member provided on the peripheral surface of a cylinder shaft. When a further improvement in the introducibility is desired, a square or trapezoid member is sometimes additionally provided on the peripheral surface of the cylinder shaft.

2) Generally, it is often the case that for the stabilization of the accuracy of toner supply, a certain degree of pressure is applied to the toner immediately before supplied to the developing apparatus to thereby bring it into a condensed state to a certain degree, and the toner is supplied in such state. Therefore, to uniformly mix the supplied toner with the carrier in the developer, it is necessary to liberate and disperse this toner in the condensed state to a certain degree. Therefore, in the popular developing apparatus, the supplied toner is loosened and dispersed by the aforedescribed screw.

3) To sufficiently charge the toner, it is necessary to perform the mixing operation of bringing much of the toner and the carrier into contact with each other. Therefore, in the popular developing apparatus, the mixing of the supplied toner with the carrier is effected by the aforedescribed screw.

As described above, to sufficiently charge the toner supplied to the developing apparatus, it is considered to be necessary to satisfy the above-described three kinds of performance by the screw, but in the construction of the conventional developing apparatus, the performance of introducing and dispersing the supplied toner is low and therefore, in many constructions, the agitation distance L was greater than the image forming width G.

So, in the developing apparatus 1 according to the present invention, an inclination of upward gradient is provided in the upstream to downstream direction of the agitating chamber 22. Thereby, a force in the direction of gravity with respect to the conveying direction acts on the developer in the agitating chamber 22 and therefore, the height of the developer surface S between the conveying portions 14b of the second screw 14 is remarkably great near the conveying portion 14b on the upstream side, and is remarkably small near the conveying portion 14b on the downstream side, and is remarkably small near the conveying portion 14b on the downstream side, and there is formed a flow of developer clearing the conveying portions 14b from the downstream side to the upstream direction.

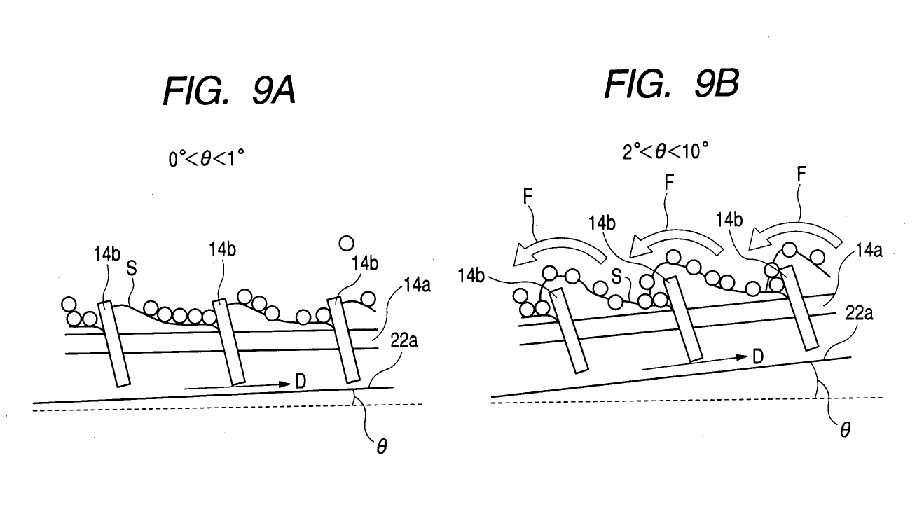

Further describing with reference also to FIGS. 9A and 9B, the movement of the developer in the agitating chamber 22 is shown in FIGS. 9A and 9B. When as shown in FIG. 9A, the inclination of the agitating chamber 22 is 1 degrees or less, the height of the developer surface S between the conveying portions 14b of the second screw 14 is relatively uniform and therefore, it never happens that the developer clears the conveying portions 14b in a direction opposite to the conveying direction (the direction indicated by the arrow D in FIG. 9A).

On the other hand, when the inclination of the agitating chamber 22 is 2 degrees or greater, as shown in FIG. 9B, the developer clears the conveying portions 14b in the direction opposite to the conveying direction (the direction indicated by the arrow D in FIG. 9B). That is, when the inclination of the agitating chamber 22 is 2 degrees or greater, there is formed a flow F of developer clearing the conveying portions 14b from the downstream side to the upstream direction with respect to the developer conveying direction. Therefore, the supplied toner not yet introduced into the developer on the downstream side between the conveying portions 14b, but wafting on the developer is readily introduced into the developer falling from the downstream side. Also, the supplied toner not yet introduced into the developer on the upstream side between the conveying portions 14b, but wafting on the developer is readily introduced into the developer when it falls in the upstream direction with the developer.

In addition, the supplied toner which is on the downstream side between the conveying portions 14b is readily dispersed by the shock of the developer falling from the downstream side, and the supplied toner which is on the upstream side between the conveying portions 14b is readily dispersed by the shock when it falls in the upstream direction with the developer.

As described above, in the present embodiment, the second screw 14 provided in the agitating chamber 22 in accordance with the present invention is upwardly inclined from the upstream side toward the downstream side with respect to the developer conveying direction, and the developer surface S in the agitating chamber 22 is set so that a part of the developer may return beyond the second screw 14. That is, an inclination of upward gradient is provided in the upstream to downstream direction of the agitating chamber 22, and preferably the inclination of the agitating chamber 22 is 2 degrees or greater, and also preferably, the developer surface S in the agitating chamber 22 is set so as to be above the second screw 14 downstream of the toner supplying position T with respect to the developer conveying direction, whereby there is formed a flow F of developer clearing the upper portions of the conveying portions 14b from the downstream side to the upstream direction. By this flow F, the introduction and dispersion of the supplied toner into the developer are readily effected and therefore, the charge giving property to the supplied toner in the agitating chamber 22 is remarkably improved, and in the first communicating portion 23, substantially all of the toner is charged to the negative polarity.

Also, it is preferable that the flow F of the developer clearing the conveying portions 14b as described above be formed over substantially all the range of the agitation distance L for agitating the supplied toner, but it is also possible to suitably set it to a length which enables sufficient charge giving to be done to the supplied toner. In the case of the present embodiment, sufficient charge giving was possible if the flow F of he developer clearing the conveying portions 14 was formed over one third or more of the agitation distance L.

Accordingly, the developing apparatus 1 of the present embodiment, as compared with the conventional one, is remarkably high in the introduction and dispersing performance of the supplied toner and therefore, it becomes possible to greatly shorten the agitation distance L necessary for the toner supply. Thereby, it is possible to charge the supplied toner sufficiently even at an agitation distance L shorter than the image forming width G which is the minimum length in the lengthwise direction required of the developing apparatus 1 and therefore, toner fog can be prevented from occurring to the blank portion of an image without the developing apparatus 1 being made bulky.

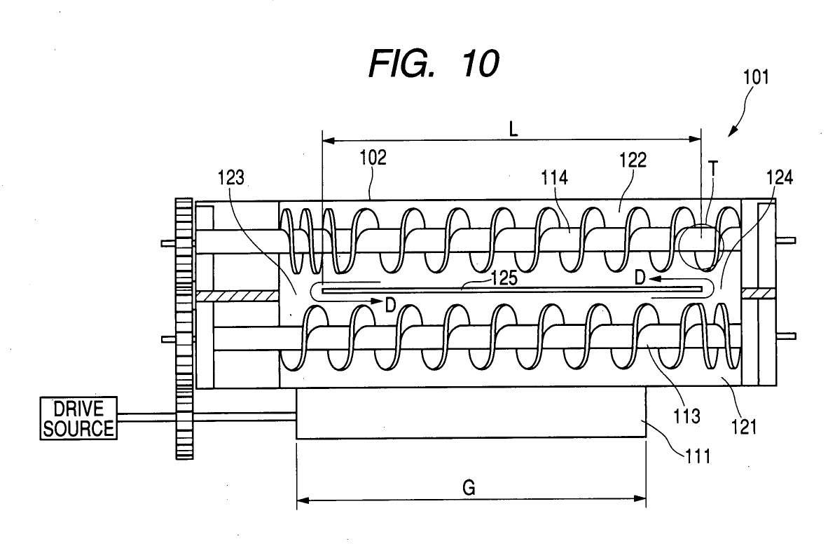

Now, even when the inclination of the agitating chamber 22 is 0 degree to 1 degree, if the agitation distance L is made greater than the image forming width G as in the conventional developing apparatus 101 shown in FIG. 10, that is, the toner supplying position T is provided upstream of the image forming region to thereby secure an agitation distance L necessary to sufficiently discharge the supplied toner, the charging polarity of the toner in the first communicating portion 23 will substantially entirely become the negative polarity. In that case, however, the agitation distance L will often become greater than the image forming width G and the developing apparatus 1 will become bulky more than necessary.

On the other hand, when the inclination of the agitating chamber 22 is 12 degrees or greater, it becomes impossible to effect the conveyance of the developer in the agitating chamber 22. This is considered to be a phenomenon attributable to the fact that the influence of the direction of gravity upon the conveying direction becomes too great. Thus, for the inclination of 12 degrees or greater, it is virtually impossible to make the conveyance of the developer hold good.

As will be understood from the foregoing, the inclination of the bottom surface 22a of the agitating chamber 22 with respect to the horizontal direction is suitably set within the range of 2 degrees to 10 degrees, whereby the supplied toner can be stably charged to a desired polarity and the circulation of the developer can be effected smoothly. Thereby, it becomes possible to prevent toner fog without making the developing apparatus 1 bulky more than necessary. By the inventor's further study, from the viewpoints of both of the charge giving property to the toner and the convey ability of the developer, the inclination of the bottom surface 22a of the agitating chamber 22 with respect to the horizontal direction is more preferably 3 degrees to 8 degrees, and still more preferably 5 degrees to 6 degrees.

As described above, according to the developing apparatus 1 of the present embodiment, the charge giving property to the toner in the agitating chamber 22 for conveying the developer to the developing chamber 21 while mixing and agitating the supplied toner and the developer is improved, whereby it becomes possible to achieve the shortening of the agitation distance L, and prevent toner fog without making the developing apparatus 1 bulky more than necessary.

As described above, it is possible to prevent toner fog without making the developing apparatus 1 according to the present invention bulky more than necessary and therefore, the image forming apparatus 100 according to the present invention provided with this developing apparatus 1 can prevent toner fog without the apparatus main body thereof being made bulky.

Second Embodiment

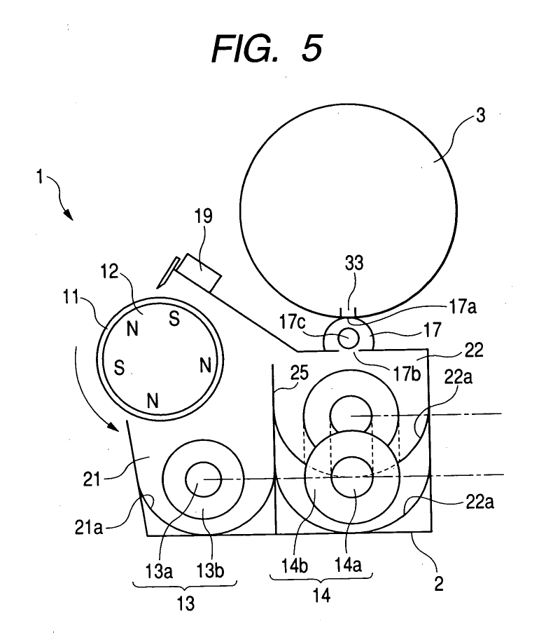

Another embodiment of the present invention will now be described with reference to FIG. 5. In the present embodiment, the present invention is embodied by a developing apparatus similar to that of the first embodiment, and an image forming apparatus provided with the same, and the basic constructions of the developing apparatus and the image forming apparatus are the same as those of the first embodiment. Accordingly, elements having constructions and action identical with or corresponding to those of the first embodiment are given the same reference characters and need not be described in detail.

In the developing apparatus 1 of the present embodiment, as shown in FIG. 5, as in the developing apparatus 1 described in the first embodiment, the bottom surface 22a of the agitating chamber 22 has an inclination of 5 degrees with respect to the horizontal direction (upward gradient from the second communicating portion 24 side toward the first communicating portion 23 side).

In the present embodiment, in the first communicating portion 23 for delivering the developer from the agitating chamber 22 to the developing chamber 21, the bottom surface 22a of the agitating chamber 22 is vertically above the bottom surface 21a of the developing chamber 21, and in the second communicating portion 24 for delivering the developer from the developing chamber 21 to the agitating chamber 22, the bottom surface 22a of the agitating chamber 22 and the bottom surface 21a of the developing chamber 21 are vertically at the same position.

Accordingly, in the second communicating portion 24, the two bottom surfaces 21a and 22a are vertically at the same position and therefore, smooth delivery of the developer from the developing chamber 21 to the agitating chamber 22 is possible. Also in the first communicating portion 23, the delivery of the developer is effected by the falling movement of the developer from the agitating chamber 22 to the developing chamber 21 and therefore, smooth delivery is possible.

The developing apparatus 1 of the present embodiment, as described above, is similar to that described in the first embodiment, in the other constructions except the differences in the vertical positional relations between the bottom surface 22a at the agitating chamber 22 and the bottom surface 21a of the developing chamber 21 in the first communicating portion 23 and the second communicating portion 24. Accordingly, again by the construction of the developing apparatus 1 of the present embodiment, an operational effect similar to that of the first embodiment can be achieved.

Third Embodiment

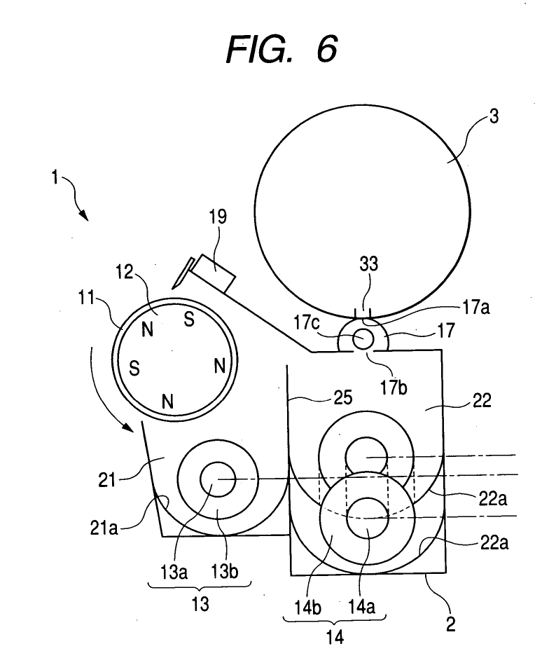

Still another embodiment of the present invention will now be described with reference to FIG. 6. This embodiment, like the above-described second embodiment, is such that relative to the developing apparatus 1 of the first embodiment, the positional relation in the vertical direction between the bottom surface 22a of the agitating chamber 22 and the bottom surface 21a of the developing chamber 21 in the first communicating portion 23 and the second communicating portion 24 is changed.

In the developing apparatus 1 of the present embodiment, as shown in FIG. 6, as in the developing apparatus 1 described in the first embodiment, the bottom surface 22a of the agitating chamber 22 has an inclination of 5 degrees (upward gradient from the second communicating portion 24 side toward the first communicating portion 23 side) with respect to the horizontal direction.

In the present embodiment, in the first communicating portion 23 for delivering the developer from the agitating chamber 22 to the developing chamber 21, the bottom surface 22a of the agitating chamber 22 is vertically above the bottom surface 21a of the developing chamber 21, and in the second communicating portion 24 for delivering the developer from the developing chamber 21 to the agitating chamber 22, the bottom surface 22a of he agitating chamber 22 is vertically below the bottom surface 21a of the developing chamber 21.

Accordingly, in both of the first communicating portion 23 and the second communicating portion 24, the delivery of the developer is effected between the developing chamber 21 and the agitating chamber 22 by the falling movement of the developer and therefore, smooth delivery is possible.

According to the construction of the developing apparatus 1 of the present embodiment, an operational effect similar to that of the first embodiment can be achieved and in addition, the delivery of the developer between the developing chamber 21 and the agitating chamber 22 can be effected smoothly.

As is apparent from the foregoing description, when in the present invention, an inclination is to be provided for the agitating chamber 22 of the developing container 2, to effect smooth delivery of the developer in the first communicating portion 23 and the second communicating portion 24, it will suffice if in the developer circulation route, design is made such that in the first communicating portion 23 for delivering the developer from the agitating chamber 22 to the developing chamber 21, the bottom surface 22a of the agitating chamber 22 is vertically at the same position as or an overlying position relative to the position of the bottom surface 21a of the developing chamber 21, and in the second communicating portion 24 for delivering the developer from the developing chamber 21 to the agitating chamber 22, the bottom surface 21a of the developing chamber 21 is vertically at the same position as or an overlying position relative to the position of the bottom surface 22a of the agitating chamber 22.

Fourth Embodiment

Yet still another embodiment of the present invention will now be described. In this embodiment, the developing apparatus according to the present invention is made detachably mountable as a process cartridge on the image forming apparatus main body. Here, the present invention will be described as being embodied by the same image forming apparatus 100 as that of the first embodiment with the exception that the apparatus is of a process cartridge type. Accordingly, elements having constructions and action identical with or corresponding to those of the first embodiment are given the same reference characters and need not be described in detail.

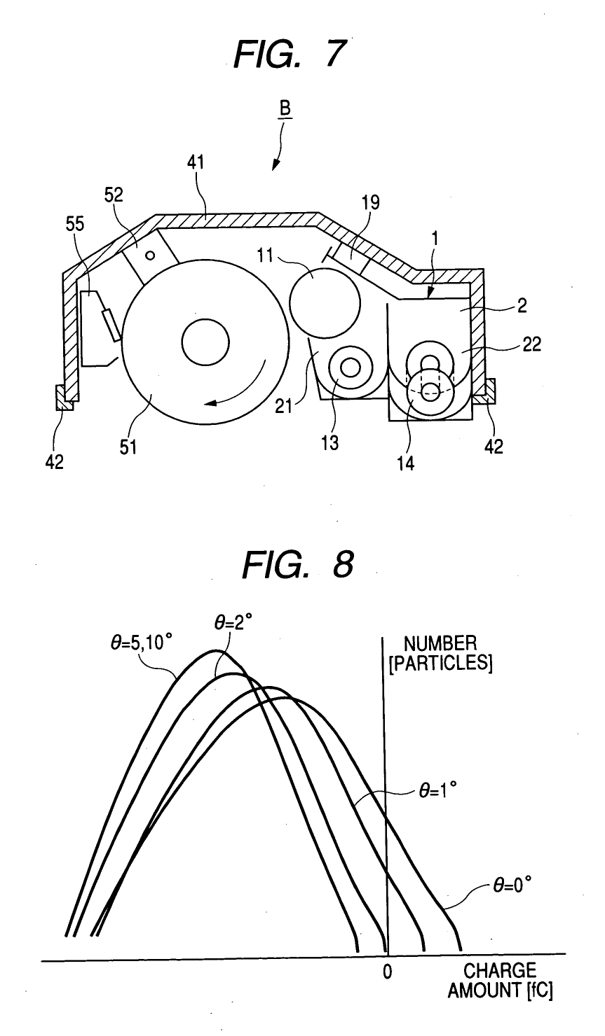

FIG. 7 shows a schematic cross-sectional view of an example of a process cartridge B provided with the developing apparatus 1 according to the present invention.

The process cartridge B of the present embodiment comprises a photosensitive drum 51, a primary charging device 52, a cleaning apparatus 55 and the developing apparatus 1 as process means acting on the photosensitive drum 51 which are integrally made into a cartridge by a frame member 41. The process cartridge B is detachably mounted with respect to an image forming apparatus main body A through mounting means 42 which is a guide, positioning means or the like provided in the image forming apparatus main body A.

When the process cartridge B is properly mounted on the image forming apparatus main body A, a drive communicating portion (not shown) provided on the image forming apparatus main body A side and a drive communicating portion (not shown) on the process cartridge B side are connected together, and a driving force from a drive source (a drive source (not shown) for the photosensitive drum 51, and a drive source 70 (FIG. 3) for the developing apparatus 1, or these may be common) provided in the image forming apparatus main body A becomes transmittable to the photosensitive drum 51 and the developing sleeve 11 provided in the process cartridge B (and further to the first screw 13 and the second screw 14). Likewise, when the process cartridge 13 is properly mounted on the image forming apparatus main body A, a contact (not shown) on the image forming apparatus main body A side and a contact (not shown) on the process cartridge B side are connected together, and a primary charging bias and a developing bias become applicable from a charging bias voltage source (not shown) and a developing bias voltage source (not shown), respectively, as voltage applying means provided in the image forming apparatus main body A to the primary charging device 52 and the developing sleeve 11.

In the present embodiment, the process cartridge B integrally has a developing apparatus 1 of the same construction as that described in the first embodiment. Of course, the developing apparatus 1 may be the developing apparatus 1 described in the second embodiment and the third embodiment.

Generally, the process cartridge B, when the photosensitive drum 51 reaches its service life or the developer in the developing apparatus 1 is remarkably deteriorated, can be bodily taken out of the image forming apparatus main body A and a new process cartridge B can be mounted to thereby restore the image forming apparatus. Thereby, it becomes possible to achieve an improvement in maintenance property, the user himself can perform the maintenance of the apparatus without resort to a serviceman having special knowledge about apparatus interchange and therefore, a reduction in the running cost of the image forming apparatus by a reduction in labor cost also becomes possible.

The process cartridge B of the present embodiment uses the developing apparatus 1 of the same construction as that of the first embodiment and therefore, about the developer circulation route in the developing container 2 of the developing apparatus 1, the movement of the developer in the agitating chamber 22 and the charge giving property to the supplied toner in the agitating chamber 22 are as described about the developing apparatus 1 of the first embodiment.

Thereby, the process cartridge B of the present embodiment holds the merit of the process cartridge type as described above, i.e., the excellence in maintenance property, and also can prevent toner fog without being made bulky more than necessary. Accordingly, in the process cartridge B according to the present invention, it becomes possible to achieve downsizing to thereby achieve a further improvement in maintenance property and a lower cost.

The image forming apparatus 100 according to the present invention on which this process cartridge B is detachably mountable can prevent toner fog without the apparatus main body being made bulky.

The process cartridge B is not restricted to the mode of he present embodiment, but can be one comprising an image bearing member which usually is an electrophotographic photosensitive member, and process means including at least developing means acting on the image bearing member, the image bearing member and the process means being integrally made into a cartridge which is made detachably mountable on an image forming apparatus main body. Accordingly, as the mode of the process cartridge, mention may be made of a mode provided with an image bearing member, charging means and developing means, or a mode provided with an image bearing member, cleaning means and developing means, besides the mode of the present embodiment provided with an image bearing member, charging means, cleaning means and developing means.

Also, a cartridge detachably mountable with respect to the image forming apparatus main body A can have its construction suitably determined with the user's maintenance property and the service life or the like of each element taken into account, and is not restricted, for example, to the above-described process cartridge (one having an image bearing member and process means acting thereon), but may be a cartridge in which only the developing apparatus 1 is detachably mountable with respect to the image forming apparatus main body A, or may be a developing apparatus and at least one of a primary charging device and a cleaning apparatus integrally made into a cartridge.

That is, the process cartridge detachably mountable with respect to the image forming apparatus main body has at least a developing apparatus, and may further comprise an image bearing member on which a toner image is formed, and at least one of charging means for charging the image bearing member, and cleaning means for cleaning the surface of the image bearing member integrally made into a cartridge. Again in this case, the image forming apparatus main body has mounting means for detachably mounting the cartridge.

While the present invention has been specifically described with respect to several embodiments, the present invention is not restricted to the above-described embodiments, but various changes are possible without departing from the spirit of the present invention. Some non-limiting modifications will be shown below.

For example, while in the foregoing embodiments, the image forming apparatus has been described as being a color electrophotographic image forming apparatus provided with a plurality of image forming portions, the image forming apparatus may be a single-color image forming apparatus having a single image forming portion.

Also, the present invention may be applied to an image forming apparatus and a developing apparatus which have one or more developing devices contained in a rotary member (developing device supporting member) rotatable in a route passing a portion opposed to an image bearing member as is well known to those skilled in the art, and in which this rotary member is rotated to thereby dispose a desired developing device at a position opposed to the image bearing member, and an electrostatic image on the image bearing member is developed to thereby form an image comprising a developer image of a single color or developer image of plural colors.

Also, while in the above-described embodiment, developer images formed on the image bearing member have been described as being successively transferred to a recording material borne and conveyed on the recording material conveying means, the present invention can equally be applied even to an image forming apparatus using an intermediate transferring system well known to those skilled in the art, i.e., a system which has an intermediate transfer member movable round in opposed relationship with the image bearing members of a plurality of image forming portions or an image bearing member on which developer images are successively formed by a plurality of developing devices, and in which a developer image comprising a plurality of kinds of developer (e.g. a full-color toner image) formed by being once superposedly transferred onto the intermediate transfer member is then collectively transferred onto a recording material.

This application claims priority from Japanese Patent Application No. 2003-206380 filed Aug. 6, 2003, which is hereby incorporated by reference herein.

1. A developing apparatus comprising:
a developer carrying member for carrying thereon a developer including a toner and a carrier, and conveying the developer to a portion opposed to an image bearing member;
a first developer containing chamber for supplying said developer to said developer carrying member;
first conveying means disposed in said first developer containing chamber for conveying the developer;
a second developer containing chamber for supplying said developer to said first developer containing chamber;
second conveying means disposed in said second developer containing chamber for conveying the developer; and
a receiving port for receiving a toner supplied from a toner supplying apparatus,
wherein said developer is circulated between said first developer containing chamber and said second developer containing chamber by said first conveying means and said second conveying means,
said second conveying means is disposed while being inclined so that a downstream side thereof with respect to a developer conveying direction may be higher in a direction of gravity, and
the toner from said receiving port is supplied from just above said second conveying means in the direction of gravity to said second conveying means.

2. A developing apparatus according to claim 1, wherein said second conveying means is inclined at 2 to 10 degrees with respect to a horizontal direction.

3. A developing apparatus according to claim 1, wherein a supplying position in said second conveying means is toward an upstream side of said second conveying means with respect to the developer conveying direction.

4. A developing apparatus according to claim 1, wherein said second conveying means has a conveying member having a screw shape, and a part of the developer being conveyed by said conveying member moves beyond said conveying member from the downstream side toward an upstream side with respect to the developer conveying direction.

5. A developing apparatus according to claim 1, wherein in a first communicating portion from said second developer containing chamber to said first developer containing chamber in a circulation direction of said developer, said first conveying means and said second conveying means are of the same height in the direction of gravity.

6. A developing apparatus according to claim 1, wherein in a second communicating portion from said first developer containing chamber to said second developer containing chamber in a circulation direction of said developer, said first conveying means is at a higher position in the direction of gravity than said second conveying means.

7. A developing apparatus according to claim 1, wherein in a first communicating portion from said second developer containing chamber to said first developer containing chamber in a circulation direction of said developer, said first conveying means is at a lower position in the direction of gravity than said second conveying means.

8. A developing apparatus according to claim 1, wherein in a first communicating portion from said second developer containing chamber to said first developer containing chamber in a circulation direction of said developer, said first conveying means is at a lower position in the direction of gravity than said second conveying means, and in a second communicating portion from said first developer containing chamber to said second developer containing chamber in the circulation direction of said developer, said first conveying means is at a higher position in the direction of gravity than said second conveying means.
